(19) United States
(12) Patent Application Publication
(10) Pub. No.: US 2017/0040072 A1
(43) Pub. Date: Feb. 9, 2017

(54) ASYMMETRIC FILTER OF NEUTRON SIGNALS FOR DETECTING POWER OSCILLATIONS IN BOILING WATER REACTORS

(71) Applicant: YOUSEF M. FARAWILA, Richland, WA (US)

(72) Inventor: YOUSEF M. FARAWILA, Richland, WA (US)

(21) Appl. No.: 14/817,183

(22) Filed: Aug. 3, 2015

(51) Int. Cl. G21C 17/00

(52) U.S. Cl. CPC G21C 17/00

(57) ABSTRACT

This invention introduces a new method for detecting power oscillations that may occur in Boiling Water Reactor (BWR) cores. According to this invention, the Average Power Range Monitor (APRM) is enabled to detect power oscillations even when the signals from the Local Power Range Monitors (LPRMs) that make up the APRM signal are not in-phase and tend to cancel out. The asymmetric filtering algorithm that is the core of this invention is applied to the individual LPRM signals before they are summed up to make a new APRM signal. The new APRM signal will increase when oscillations occur, regardless of the instability type, and can thus be used for detecting reactor instability and enable the operator or automatic reactor protection systems to actuate and prevent reactor fuel damage.

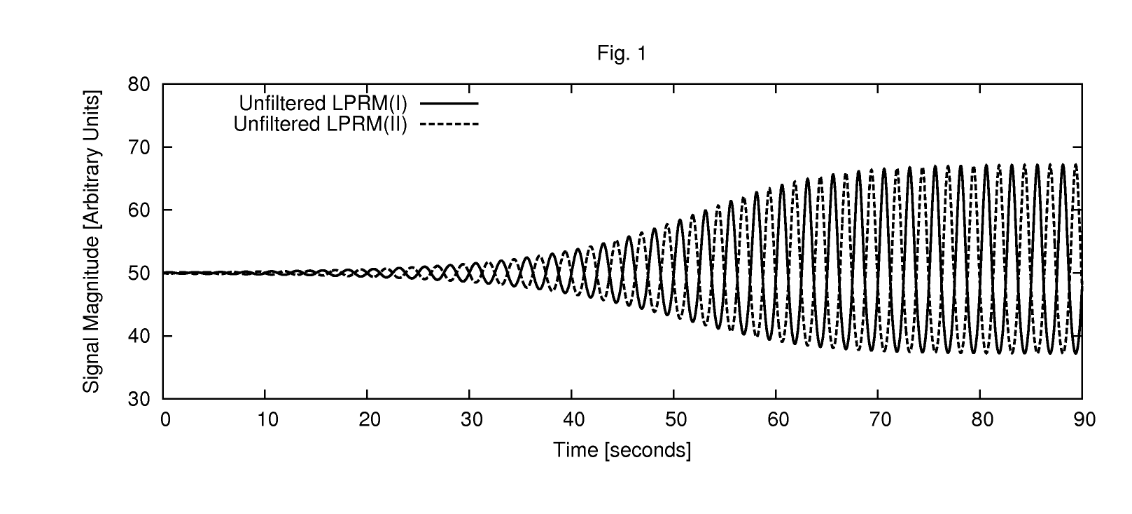

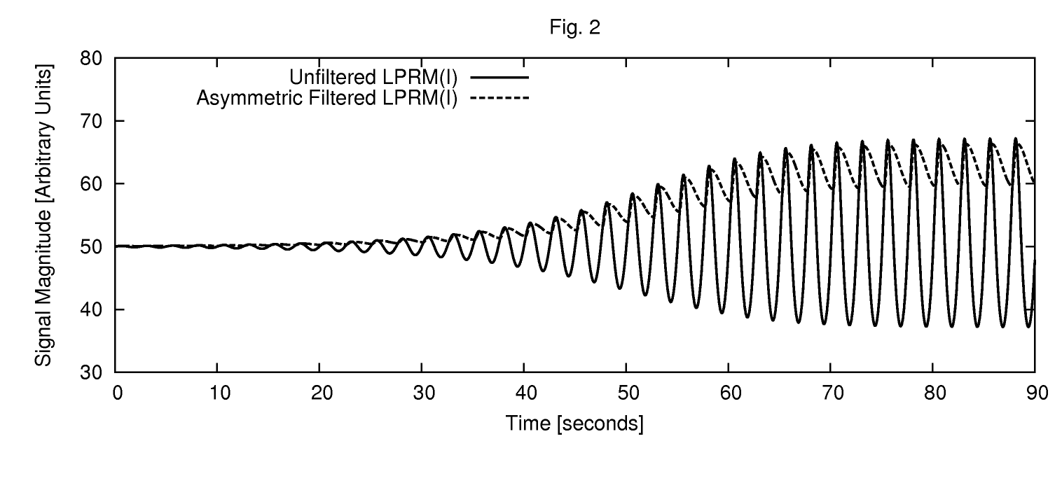

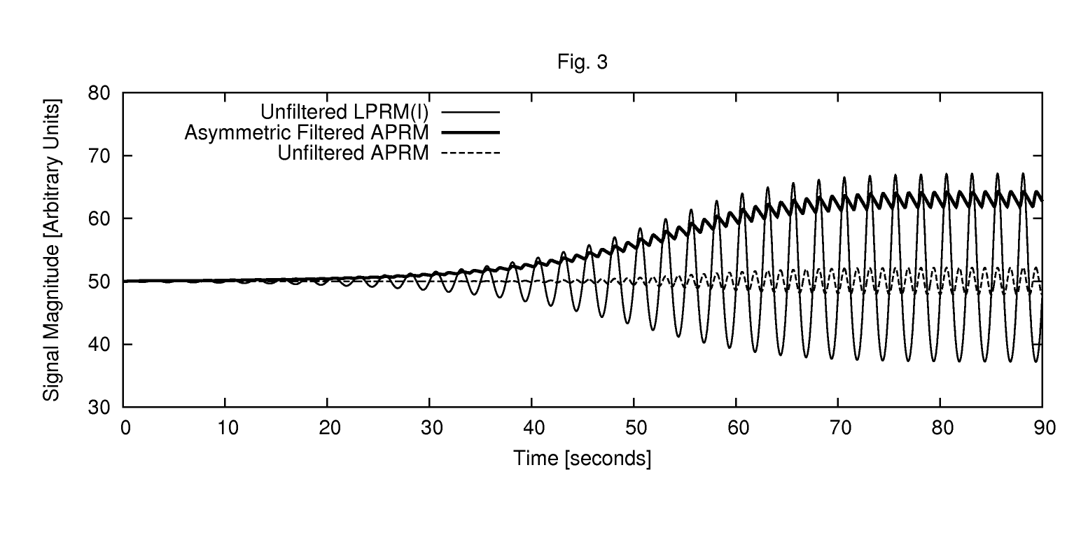

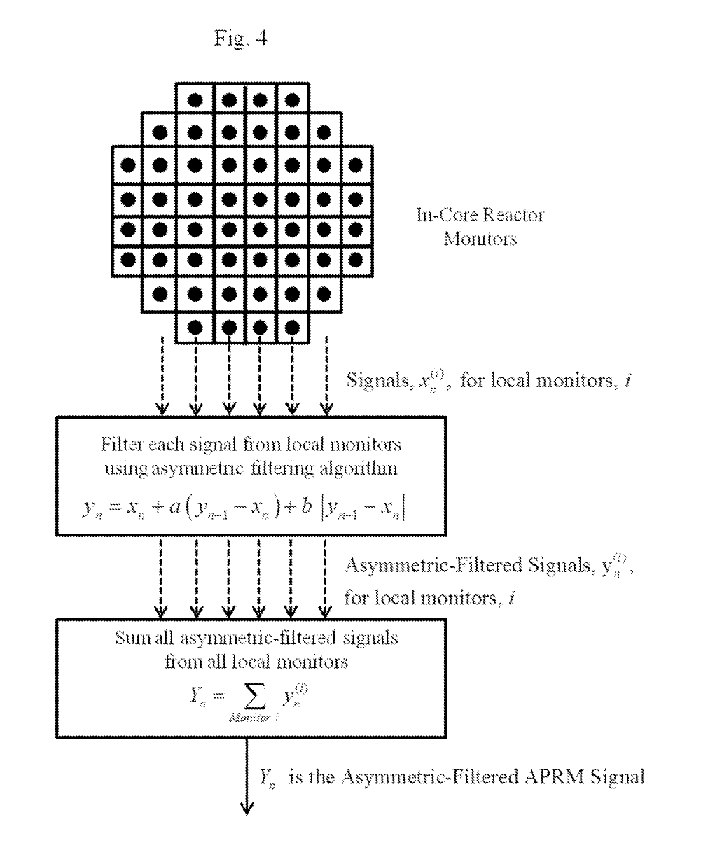

### FIELD OF THE INVENTION

The present invention relates to boiling water reactors (BWR). More specifically, a new method and algorithm are disclosed for detecting power oscillations using the Average Power Range Monitor (APRM) signals. The method is applicable regardless of the unstable power oscillation type being of the global mode or the regional out-of-phase mode.

### BACKGROUND OF THE INVENTION

The power and flow in the core of a boiling water reactor is known to become unstable under conditions of relatively high power and low flow, and especially when the temperature of the coolant flow entering the core is reduced due to loss of feedwater heater function. Such unstable conditions could be arrived at during normal operation, such as during reactor startup, or following recirculation pump trip. Once the reactor reaches unstable state, power and flow will undergo oscillations with growing amplitude. If left to grow without operator or reactor protection system acting to suppress the oscillations, the thermal limits for safe operation of the fuel could be exceeded and fuel failure becomes possible. That is why it is not allowed to operate a nuclear reactor under these conditions, which is stated in the Nuclear Regulatory Commission (NRC) General Design Criterion (GDC12). The GDC12 mandates that such oscillations be detected and suppressed before violating the limits of safe operation.

The power oscillations may be of the global mode or the regional mode. In the global mode, the power of all the fuel assemblies in the core oscillate coherently in-phase with each other. In this way, the signals from individual LPRMs are in-phase with each other, and are in-phase with the APRM signal which is the sum of these LPRM signals. The global mode is therefore easy to detect, and the APRM signal which is used to represent the total reactor power can be used by the reactor protection system to scram in case the power oscillation magnitude exceeds the flow-biased scram level. This is not the case for the regional mode of oscillations, where the power in the fuel assemblies in one half of the reactor core oscillate in-phase with each other, but out-of-phase with the power oscillation of the fuel assemblies in the other half of the reactor core. This oscillation mode is hard to detect using the APRM signal, because the signal contains contributions from LPRMs that oscillate out-of-phase with each other and substantially cancel out to the effect that the APRM signal remains quite or experience a much reduced oscillation amplitude compared with the power oscillation experienced by individual fuel assemblies.

The prior art addresses this problem in different ways. One way of addressing the problem of unstable power oscillations is at the reactor fuel design level where fuel stability characteristics are either improved or at least preserved compared to older fuel designs; however, this is not sufficient and the reactor stability requires other measures to protect. There are commonly used long term stability solutions that are acceptable to the NRC. One of these solutions is the region exclusion solution, where calculations are performed in advance of each reactor fuel loading cycle to determine the area defined on the power-flow operating map where instability is possible; and the reactor protection system is set up to automatically shut down the reactor if the boundary of the excluded area is violated. This solution is acceptable, but is implemented at a cost of losing some operational flexibility as the excluded area must be defined conservatively.

The other long term stability solution is the Detect & Suppress (D&S) solution where an Oscillation Power Range Monitor (OPRM) signals are obtained from grouping of LPRMs that are closely spaced and represent different regions of the reactor core. The individual OPRM signals are processed online by algorithms that can detect the signal transition from random noise to coherent signal which occur near the instability threshold. This so-called Period-Based Detection Algorithm (PBDA) essentially detects the time period between signal peaks and considers the signal coherent when the successive periods fall within a specified tolerance. One drawback of the OPRM PBDA system is that it may result in spurious (unnecessary) scram when activated by noise that may appear by chance to represent a coherent oscillatory signal. Other costly augmentations of the OPRM system become necessary when the reactor power rating is increased and the reactor become fundamentally less stable.

The problem this invention addresses is finding a novel way to enable the reliable APRM signal to detect regional mode oscillations.

### BRIEF SUMMARY OF THE INVENTION

In accordance with the present invention, the individual LPRM signals are passed through a novel filter. The said filter is biased to pass signals with positive slope (that is of rising magnitude with time) more than when the signal has a negative slope. Steady state signal will pass unchanged, while oscillating signal will cause a bias in the positive direction that is proportional to the amplitude of the oscillatory component in the unfiltered signal. A new APRM signal composed of the sum of the filtered LPRM signals will show a net positive bias when the reactor power is oscillating. Most importantly, a regional more power oscillation where individual unfiltered LPRM signals are out-of-phase, will not cancel out completely and a significant APRM positive signal rise results from any type of reactor power oscillation. This property of the asymmetric filtering allows the new APRM signal to be utilized for power oscillation detection regardless of the oscillation type. The ultimate use of the new APRM signal is to use to to actuate reactor protection systems and mitigate the reactor instability and protect against fuel failure.

### BRIEF DESCRIPTION OF THE DRAWINGS

FIG. (1) depicts these unfiltered signals, xₙ^{(I)}, and xₙ^{(II)}, where the two signals represent a growing instability, and the two signals are out-of-phase.

FIG. (2) depicts the LPRM^{(I)} signal before filtering, xₙ^{(I)}, and after asymmetric filtering, yₙ^{(I)}. It is demonstrated that the asymmetric filtering produces a bias to higher amplitude as the oscillation magnitude grows.

FIG. (3) depicts the unfiltered signal, xₙ^{(I)}, the unfiltered APRM signal, Xₙ, and the asymmetric-filtered APRM signal, Yₙ. It is clearly shown that the unfiltered APRM signal is initially very small due to the input signals contributing to it cancelling each other out.

FIG. (4), For application in a BWR plant for the purpose of conditioning the power measuring instrumentation and detection of power oscillations, the process is illustrated using a flowchart as given in FIG. (4).

### DETAILED DESCRIPTION OF THE INVENTION

The new filter introduced for this invention is an asymmetric one. By the term “asymmetric” it is meant that the filter passes more of the input signal when it is increasing in time, and vice versa. As a preferred embodiment, a first order moving average filter is shown below.

Consider a signal, x(t), represented by the time series, xₙ, n=1, 2, . . . , N. The discrete points are separated by a uniform time interval, Δt. The filtered signal time series, yₙ, is obtained from the recursive relation

yₙ=cyₙ₋₁+(1−c)xₙ (9)

where the filter constant, c, is obtained from the signal time step, Δt, and the filter frequency, f, using the following equation:

$$c = \frac{1}{1 + f Δ t} \qquad ( 10 )$$

In the asymmetric filter, two values of the filtering frequency are used, where the high frequency is used when the signal is rising in time, and the low frequency is applied when the signal is declining in time. Thus, the asymmetric filtering is represented by the filter constant

$$c = \{ \begin{matrix}\frac{1}{1 + {f}_{1} Δ t} for {x}_{n} > {y}_{n - 1} \\ \frac{1}{1 + {f}_{2} Δ t} for {x}_{n} \leq {y}_{n - 1}\end{matrix} \qquad ( 11 )$$

where the two filtering frequencies are not equal, and f₁>f₂. Representative values of the filtering frequencies are given for illustration purpose as f₁=10 Hz and f₂=0.2 Hz.

A one-line recursive relation for the asymmetric filter, equivalent to Eqn. (3), is

yₙ=xₙ+a(yₙ₋₁−xₙ)+b|yₙ₋₁−xₙ| (12)

where the constant filtering coefficients, a and b, are calculated from

$$\begin{matrix}a = \frac{1}{2} ( \frac{1}{1 + {f}_{1} Δ t} + \frac{1}{1 + {f}_{2} Δ t} ) & ( 13 ) \\ and & \\ b = \frac{1}{2} ( \frac{1}{1 + {f}_{2} Δ t} - \frac{1}{1 + {f}_{1} Δ t} ) & ( 14 )\end{matrix}$$

A calculation example is given below for a time series, xₙ^{(I)}, which represents the neutron flux measurement of the local power ranger monitor, LPRM^{(I)}. The time series, xₙ^{(II)}, represents the neutron flux measurement of the local power range monitor, LPRM^{(II)}. The two measurements are out-of-phase. FIG. (1) depicts these unfiltered signals, xₙ^{(I)}, and xₙ^{(II)}, where the two signals represent a growing instability, and the two signals are out-of-phase.

The asymmetric filter of Eqn. (4) is used to generate the filtered signal, yₙ^{(I)}, from the input signal xₙ^{(I)}. Similarly, the filtered signal, yₙ^{(II)}, is generated from the input signal xₙ^{(II)}. The signals are given at time step intervals of Δt=0.02 seconds, and the filtering frequencies are f₁=10 Hz and f₂=0.2 Hz.

FIG. (2) depicts the LPRM^{(I)} signal before filtering, xₙ^{(I)}, and after asymmetric filtering, yₙ^{(I)}. It is demonstrated that the asymmetric filtering produces a bias to higher amplitude as the oscillation magnitude grows.

The unfiltered average power range monitor signal, Xₙ, is created by averaging the unfiltered signals. Thus,

$${X}_{n} = \frac{1}{2} ( {x}_{n}^{( I )} + {x}_{n}^{( II )} ) \qquad ( 15 )$$

The asymmetric-filtered average power range monitor signal, Yₙ, is similarly obtained by averaging the individual asymmetric-filtered signals. Thus,

$${Y}_{n} = \frac{1}{2} ( {y}_{n}^{( I )} + {y}_{n}^{( II )} ) \qquad ( 16 )$$

FIG. (3) depicts the unfiltered signal, xₙ^{(I)}, the unfiltered APRM signal, Xₙ, and the asymmetric-filtered APRM signal, Yₙ. It is clearly shown that the unfiltered APRM signal is initially very small due to the input signals contributing to it cancelling each other out. A residual oscillation is found in the unfiltered APRM signal when the oscillation magnitude is large, which is attributable to the nonlinear effects causing the individual LPRM signals to deviate from pure sinusoidal time variation. The unfiltered APRM signal remains close to the noise level in a real BWR reactor core at the time when oscillation suppression is needed (in the time interval of 40-50 seconds in the FIG. (3) illustration). By contrast, FIG. (3) shows the asymmetric-filtered APRM signal to show significant response to the rising oscillation magnitude. The asymmetric-filtered APRM signal is thus demonstrated to be a viable indicator of power oscillations even when the oscillation mode is of the out-of-phase regional type.

For application in a BWR plant for the purpose of conditioning the power measuring instrumentation and detection of power oscillations, the process is illustrated using a flowchart as given in FIG. (4).

1. A method for creating an average power range monitor signal for a boiling water reactor from summing up the individual local power range monitors, where the signals from said local power range monitors are filtered using asymmetric filtering algorithm; the said algorithm is asymmetric in the sense that it responds faster when the input signal to the filter is rising in time and slower when the input signal is declining in time.

2. A filtering algorithm that possesses the characteristic of producing a positive bias in its output signal when its input signal is oscillating.

3. The filtering algorithm in claim 2 where the characteristic of producing a positive bias in its output signal when its input signal is oscillating is achieved by a recursive relationship of the form yₙ=xₙ+a(yₙ₋₁−xₙ)+b|yₙ₋₁−xₙ| where xₙ is a time series of input data points defined at regular time step intervals between every two successive data points n and n−1, the output signal is yₙ, the coefficients a and b determine the filtering characteristics, and b>0 causes the output signal to have a positive bias in case the input signal is oscillating.

4. The filtering algorithm in claim 2 where the characteristic of producing a positive bias in its output signal when its input signal is oscillating is achieved by mathematical forms equivalent to the recursive relation given in claim 3 or using other higher order forms to program digital or analogue computing equipment.

5. A reactor protection system where in-core neutron detectors distributed in the core provide measurements of neutron flux indicative of the power in the adjacent fuel elements, a a digital or analogue computer equipment to execute the function of filtering the signal from the individual local detectors, the said filtering process is asymmetric where a positive bias is produced when the input signal is oscillating, an average power signal computed by summing the filtered signals from individual detectors, the average signal having the characteristic of exhibiting positive bias when the individual detector signals are oscillating regardless of the phase of the said oscillations, and the said reactor protection system causes the reactor to shut down when the positive bias of the average power signal exceeds a predetermined level.
